(19) United States
(12) Patent Application Publication
(10) Pub. No.: US 2024/0198996 A1
(43) Pub. Date: Jun. 20, 2024

(54) ELECTRONICALLY CONTROLLABLE PNEUMATIC BRAKING SYSTEM WITH FAILSAFE BRAKING APPLICATION FOR AUTONOMOUS DRIVING, HAVING ONLY ONE SHUTTLE VALVE

(71) Applicant: ZF CV Systems Global GmbH, Bern (CH)

(72) Inventor: Julian van Thiel, Grossburgwedel (DE)

(21) Appl. No.: 18/589,123

(22) Filed: Feb. 27, 2024

Related U.S. Application Data
(63) Continuation of application No. PCT/EP2022/071541, filed on Aug. 1, 2022.

(30) Foreign Application Priority Data
Aug. 31, 2021 (DE) 10 2021 122 501.9

(51) Int. Cl. B60T 17/22; B60T 8/26; B60T 13/66; B60T 15/02

(52) U.S. Cl. CPC B60T 17/221; B60T 13/662; B60T 15/027; B60T 8/26; B60T 2270/413; B60T 2270/88

(57) ABSTRACT

An electronically controllable pneumatic braking system for a vehicle includes a first control unit for a primary system and a second control unit for a first fallback level, and a monostable fail-safety valve unit which pneumatically connects a main port, which provides a first pressure, and a failure brake port. The fail-safety valve unit is connected to both control units and in a fault situation, power failure and/or diagnostic situation of the control units, provides the failure brake pressure for triggering a failure braking operation. The failure brake port is connected to the primary system and/or to the first fallback level upstream of a functional pneumatic unit of the primary system and/or the first fallback level, in such a way that both front axle service brake actuators and rear axle service brake actuators have a brake pressure applied thereto in order to implement the failure braking operation.

### CROSS-REFERENCE TO RELATED APPLICATIONS

This application is a continuation application of international patent application PCT/EP2022/071541, filed Aug. 1, 2022, designating the United States and claiming priority from German application 10 2021 122 501.9, filed Aug. 31, 2021, and the entire content of both applications is incorporated herein by reference.

### TECHNICAL FIELD

The disclosure relates to an electronically controllable pneumatic braking system for a vehicle which is preferably a utility vehicle. The electronically controllable pneumatic braking system has a first control unit for a primary system and a second control unit for a first fallback level, wherein the first control unit and the second control unit are supplied with energy independently of one another and/or can at least partially replace one another in terms of their function. Moreover, a monostable fail-safety valve unit is provided, the monostable fail-safety valve unit pneumatically connecting a main port, which provides a first pressure, and a failure brake port, wherein the fail-safety valve unit is connected both to the first control unit and to the second control unit and in a fault situation and/or power failure and/or diagnostic situation of the first control unit and the second control unit provides a failure brake pressure on the failure brake port. In a second aspect, the disclosure also relates to a vehicle having such an electronically controllable pneumatic braking system.

### BACKGROUND

Safety concepts are very relevant in electropneumatic braking systems for modern vehicles. In particular, in vehicles with automated or partially automated driving functions, concepts for triggering a failure braking operation in a fault situation or a power failure of a control unit contribute significantly to the safety of the vehicle, the occupants thereof and other traffic users. Such concepts permit safe braking and stopping of the vehicle in a fault situation, such as for example a power failure.

In principle, there are concepts which implement a failure braking operation via a service braking system and those which implement this via a holding braking system. Braking systems frequently also implement both concepts in order to provide two or more fallback levels which are then based on the different concepts. In the case of concepts based on a holding braking system, in principle there is the advantage that by venting a pretensioned spring brake cylinder a secure hold of the vehicle can be achieved without having to pressurize a brake actuator with compressed air.

Thus DE 10 2019 131 930 A1 already describes an electropneumatic holding brake module for an electronically controllable pneumatic braking system for a vehicle with a supply port for receiving a supply pressure, at least one holding brake port for connecting at least one spring brake cylinder, a main valve unit which receives the supply pressure and which is configured to modulate a spring mechanism pressure on the holding brake port as a function of a control pressure, and a pilot valve arrangement receiving the supply pressure for providing the control pressure, wherein the pilot valve arrangement has a bistable valve which can be switched between a first ventilation position and a second venting position and a control unit for providing first and second switching signals to the pilot valve arrangement.

In the electropneumatic holding brake module disclosed in DE 10 2019 131 930 A1 the pilot valve arrangement has a monostable holding valve which is connected pneumatically in series to the bistable valve and is arranged in a control line of the main valve unit, wherein the holding valve is opened in the de-energized state in an open position, and the control unit is configured to hold the holding valve in the holding position for holding the control pressure via the first switching signal, and a selector valve unit is arranged in the control line between the holding valve and a control port of the main valve unit with a first selector valve port for receiving an auxiliary control pressure provided at an auxiliary brake pressure port, wherein the selector valve unit has a non-return characteristic at the first selector valve port such that the first selector valve port opens in a direction of flow from the auxiliary brake pressure port via a third selector valve port to the control port and is blocked counter to the direction of flow.

A fail-safety valve unit for a failure braking function of an electronically controllable pneumatic braking system, which also serves to permit safe stopping of the vehicle when redundant systems, subsystems or levels of the braking system fail, is disclosed in US 2022/0274573. The braking system disclosed therein has a first control unit and a second control unit which are supplied with energy independently of one another and/or can at least partially replace one another in terms of their function. The fail-safety valve unit has a first failure brake valve configured as a monostable valve, and a second failure brake valve configured as a monostable valve, as well as a valve main line which pneumatically connects a main port providing a first pressure and a failure brake port. In the disclosure therein, the first failure brake valve and the second failure brake valve are pneumatically connected in series in the valve main line. The first failure brake valve is controllable by the first control unit and the second failure brake valve is controllable by the second control unit. The failure brake valves are opened in the inactivated, in particular de-energized, state in an open position, such that the first pressure applied to the main port is provided as failure brake pressure at the failure brake port such that in a fault situation and/or power failure and/or diagnostic situation of the control units a failure braking operation of the vehicle is triggered by the provision of the failure brake pressure at the failure brake port by the braking system.

This system functions very well in principle and, in particular, the fail-safety valve unit has proved advantageous. However, with this solution there is still the need to optimize further the stability of the system, the reaction speed and the pipework.

Other systems for implementing pneumatic redundancies are disclosed, for example, in US 2019/0152459, DE 10 2018 205 957 A1, EP 2 090 481 A1, DE 103 57 373 A1, US 2019/0248351, US 2020/0023827 and US 2019/0337503. Thus, for example, an electronically controllable pneumatic braking system with at least two brake circuits is disclosed in US 2019/0152459, wherein at least one of the at least two brake circuits is assigned an electronically and pneumatically controllable control valve and another of the at least two brake circuits is assigned an electrically controllable parking brake valve, in order to predetermine brake pressures for activating wheel brakes of the respective brake circuit. A first control unit is provided, the first control unit being configured to activate electrically the respective control valve as a function of an automatically requested target vehicle deceleration or an actuation predetermined by the driver via an actuating device, and a second control unit is provided, the second control unit being configured to control electrically the parking brake valve as a function of the automatically requested target vehicle deceleration, when an electrical activation of the respective control valve is prevented. According to this disclosure at least one bypass valve is also provided, the bypass valve being assigned to the control valve and being configured to activate pneumatically the assigned control valve, wherein the pneumatic activation takes place as a function of the automatically requested target vehicle deceleration or as a function of the actuation of the actuating device predetermined by the driver when an electrical activation of the respective control valve is prevented, in order to increase the electronically pneumatically controlled redundancy.

It is the object of the present disclosure to specify an electronically controllable pneumatic braking system of the type mentioned in the introduction which is improved in terms of stability, which is less prone to faults and/or can permit shorter or more efficient pipework.

The object is achieved in an electronically controllable braking system of the type mentioned in the introduction, in that in order to provide the failure brake pressure for triggering a failure braking operation of the vehicle, the failure brake port is connected to the primary system and/or the first fallback level upstream of a functional pneumatic unit of the primary system and/or the first fallback level, in such a way that both front axle service brake actuators and rear axle service brake actuators have a brake pressure applied thereto in order to implement the failure braking operation.

While in the prior art according to US 2022/0274573 the failure brake port for providing the failure brake pressure for triggering the failure braking operation is coupled via a second shuttle valve into the front axle brake circuit, and namely specifically into a line which leads to a redundancy pressure port of a front axle modulator, the present disclosure provides that, on the one hand, the failure brake port is connected to the primary system or to the fallback level upstream of a functional pneumatic unit of the primary system and/or the first fallback level and, on the other hand, when the failure brake pressure is provided both the front axle service brake actuators and the rear axle service brake actuators can have a brake pressure applied thereto. In the prior art according to US 2022/0274573, in a failure braking operation only spring brake cylinders can be actuated on the rear axle, and no service brake actuators. When spring brake cylinders are actuated for implementing redundant braking, other control parameters are required and reaction times differ from those of the service brake actuators, so that in principle it is desirable to use service brake actuators for implementing redundant braking.

The coupling of the failure brake pressure upstream of a functional pneumatic unit of the primary system and/or the first fallback level leads to greater stability and availability of the system. A functional pneumatic unit of the primary system and/or the first fallback level are understood to mean, in particular, such units which can be activated pneumatically and/or electrically and can modulate a pressure pneumatically provided thereto. Examples thereof are axle modulators, parking brake modules, trailer control valves, air conditioning systems, brake pedals, and the like.

The stability of the system can be enhanced by additionally using already existing systems, namely in particular functional pneumatic units of the primary system and/or the first failure fallback level, the failure brake pressure being input upstream thereof. In comparison with US 2022/0274573, in particular, a shuttle valve can be dispensed with. As a result, not only is one component saved but also additional sources of faults can be avoided and thereby the stability of the system enhanced.

According to a first embodiment, it is provided that the fail-safety valve unit has a first failure brake valve configured as a monostable valve, a second failure brake valve configured as a monostable valve, and a valve main line, wherein the first failure brake valve and the second failure brake valve are pneumatically connected in series in the valve main line. Preferably, the first failure brake valve is controllable by the first control unit and the second failure brake valve is controllable by the second control unit. Preferably, the failure brake valves in the inactivated state are in an open position, such that the first pressure applied to the main port or a pressure derived therefrom is provided as failure brake pressure at the failure brake port. If the failure brake valves are activated by two different control units, that is, in each case are assigned to one control unit, the failure brake valves are held in each case in a blocked state by different control units in the activated state independently of one another by a control signal. The control units are supplied with energy, in particular, independently of one another. The fact that the control units can at least partially replace one another in terms of their function means, in particular, that if the first control unit should fail, the second control unit can provide functions of the first control unit redundantly in the sense of a fallback level. In the case of a multiple fault, that is, a fault which relates to a plurality of control units, and in particular a double fault which relates to the primary system with the first control unit and a first fallback level with the second control unit, due to the monostable de-energized opening behavior of the failure brake valves in the inactivated state, that is, when the control signal is absent for the failure brake valves, the fail-safety valve unit can provide a first pressure applied to a main port as failure brake pressure at the failure brake port for the braking system. The embodiment includes the knowledge that with a plurality of subsystems of a braking system, in each case with independent control units, a fault can be advantageously manifested by the absence of a control signal for the respective failure brake valve assigned to the control unit. This can be the case, for example, in a power failure, that is, if the power supply for the control unit malfunctions. The control unit can also be configured such that in the case of an exceptional fault, in particular a case in which the control logic can no longer ensure the safety of the vehicle, a zero signal is emitted as a control signal for the failure brake valve and thus an absence of the control signal is simulated. If this is the case, that is, if a fault is present on both subsystems, in particular in the form of an exceptional fault or power failure, the fail-safety valve unit ensures a safe deceleration of the vehicle by the provision of the failure brake pressure. A double fault here represents a special case of the multiple fault, in which two subsystems are affected at the same time by one fault.

Within the scope of this embodiment, three or more failure brake valves connected in series can also be provided in order to take into account further fallback levels or other systems. Further control units can also be connected to the failure brake valves in order to be able to represent the presence of different multiple faults. It is also possible that two or more control units are connected to a failure brake valve and provide signals thereto. It can also be provided that a control unit outputs a corresponding signal to a plurality of failure brake valves.

According to an embodiment, the electronically controllable pneumatic braking system has a front axle modulator which is electronically connected to the first control unit and which receives front axle service brake signals from the first control unit, and in response thereto provides a front axle service brake pressure on a first front axle service brake actuator and a second front axle service brake actuator on a front axle of the vehicle. The braking system also has a rear axle modulator which is electronically connected to the first control unit and which receives rear axle service brake signals from the first control unit, and in response thereto provides a rear axle service brake pressure on at least one first rear axle service brake actuator and a second rear axle service brake actuator on the rear axle of the vehicle. The front axle modulator and the rear axle modulator can be provided as separate structural units in the braking system. It can also be provided that the first control unit is integrated with the front axle modulator or the rear axle modulator in one structural unit, in order to form a module in this manner. The front axle modulator and the rear axle modulator can be connected to the first control unit both via a bus system and via direct cabling in order to receive the front axle service brake signals and rear axle service brake signals therefrom. If direct cabling is provided, the front and rear axle modulators preferably include output stages.

Preferably, the first control unit is connected via a vehicle bus to a unit for autonomous driving and receives braking request signals therefrom and on the basis thereof provides the front axle service brake signals and/or rear axle service brake signals. The first control unit is provided to implement the braking request signals of the unit for autonomous driving and to provide the corresponding front axle service brake signals and rear axle service brake signals for the front axle modulator and the rear axle modulator. If the pneumatic braking system also includes a trailer control unit, the first control unit preferably also provides service brake signals for the trailer control unit which then can activate a trailer connected to the vehicle in accordance therewith.

Preferably, a front axle redundancy pressure line, into which a front axle redundancy pressure can be input for the redundant braking of the front axle, is provided. A rear axle redundancy pressure line, into which a rear axle redundancy pressure can be input for the redundant braking of at least one rear axle, is preferably also provided. The vehicle can also have two or more axles, wherein the rear axle redundancy pressure is preferably provided for the two or more rear axles. The front axle redundancy pressure line can be connected, for example, to a redundancy port of the front axle modulator which then can pneumatically implement the front axle redundancy pressure received thereon and output the front axle brake pressure as a function of the received front axle redundancy pressure. It can also be provided that the front axle redundancy pressure is directly output to the front axle service brake actuators, in order to brake the front axle redundantly. In a similar manner, the rear axle redundancy pressure line can be connected to the rear axle modulator, preferably to a redundancy port of the rear axle modulator, which then can implement the received rear axle redundancy pressure pneumatically and output the rear axle brake pressure as a function of the rear axle redundancy pressure. It is also conceivable that the rear axle redundancy pressure line is connected directly to the rear axle service brake actuators in order to brake the rear axle redundantly.

According to an embodiment, the braking system includes a redundancy valve unit which is activated by the second control unit. Preferably, the second control unit is integrated with the redundancy valve unit in one structural unit, preferably as a module.

The redundancy valve unit is preferably constructed in the manner of a modulator. It is preferably provided to input the front axle redundancy brake pressure into the front axle redundancy pressure line. It is also preferably provided to input the rear axle redundancy pressure into the rear axle redundancy pressure line. The redundancy valve unit can be configured, for example, in the manner of a two-channel modulator in order to output both the front axle redundancy pressure and the rear axle redundancy pressure. To this end, the redundancy valve unit preferably has one or more electrically switchable solenoid valves. The signals required for switching the solenoid valves are provided by the second control unit. In this manner, the redundancy valve unit forms with the second control unit a fallback level in the braking system since the second control unit is independent of the first control unit and can at least partially replace this first control in terms of function. The redundancy valve unit can then output both the front axle redundancy pressure and the rear axle redundancy pressure which is then implemented on the front and rear axle in order to brake the vehicle.

Preferably, the second control unit is connected via a vehicle bus or the vehicle bus to a unit or the unit for autonomous driving and receives braking request signals therefrom. On the basis of the braking request signals, the second control unit switches valves of the redundancy valve unit and the front and rear axle redundancy pressure are output, either in a manner which is appropriate for each axle or uniformly. In this manner, the second control unit can replace the first control unit entirely or virtually entirely.

According to a further embodiment, it is provided that the redundancy valve unit has a failure control port which can be connected or is connected to the failure brake port, wherein the redundancy valve unit is configured to output the front axle redundancy pressure and/or rear axle redundancy pressure pneumatically on the basis of the failure brake pressure. Preferably, the redundancy valve unit is provided only in a fault situation and/or power failure and/or diagnostic situation of the second control unit to output the front axle redundancy pressure and/or rear axle redundancy pressure on the basis of the pressure received on the failure control port from the failure brake port. In this embodiment, the failure brake port is thus connected upstream of the redundancy valve unit to the braking system. In this embodiment, the redundancy valve unit is thus a functional pneumatic unit of the type mentioned in the introduction. In terms of its function blocking the failure brake pressure, the redundancy valve unit replaces one of the shuttle valves as are provided according to US 2022/0274573. The second control unit undertakes the control of the electronically controllable pneumatic braking system in the event that the first control unit does not function or does not function correctly. If the second control unit also does not function or does not function correctly, the front axle and the rear axle can be braked on the basis of the failure brake pressure, which in this case is preferably pneumatically processed by the redundancy valve unit.

According to a further embodiment, the electronically controllable pneumatic braking system includes a brake value encoder with at least one brake value encoder-brake pressure port for providing a brake value encoder-brake pressure. The brake value encoder-brake pressure port is preferably connected or can be connected to the front axle redundancy pressure line and/or the rear axle redundancy pressure line. This concept, which is known in principle, makes it possible to feed the brake value encoder-brake pressure into the front or rear axle redundancy pressure line via the brake value encoder, so as to be able to brake the vehicle manually in this manner.

In an embodiment, the brake value encoder has a brake value encoder-redundancy port which is connected to the failure brake port, wherein the brake value encoder is configured to output the brake value encoder-brake pressure pneumatically on the basis of the failure brake pressure. In this embodiment, the failure brake port is connected upstream of the brake value encoder to the braking system, so that the brake value encoder in this case represents a functional pneumatic unit according to the embodiment described in the introduction. The brake value encoder is arranged between the failure brake port, that is, also between the fail-safety valve unit and in this case the front axle and rear axle modulator. In the event that the first and the second control unit are functioning, the brake value encoder can also be used to block out the failure brake pressure and thus to prevent braking on the basis of the failure brake pressure.

In a preferred manner, the brake value encoder-brake pressure port is connected to a fail-safety valve unit-control port of the fail-safety valve unit, wherein in the absence of the fault situation and/or power failure and/or diagnostic situation of the first control unit and the second control unit, the fail-safety valve unit is configured to connect the fail-safety valve unit-control port to the failure brake port for activating the brake value encoder-brake pressure. This embodiment is in contrast to the previous embodiment, namely such that the brake value encoder is arranged upstream of the fail-safety valve unit. However, the fail-safety valve unit and the failure brake port are still upstream of the front axle modulator and thus upstream of a functional pneumatic unit of the primary system. However, in this case the fail-safety valve unit can block out the brake value encoder-brake pressure as long as the first and second control unit are functioning. Only when the first and the second control unit do not function or do not correctly function does the fail-safety valve unit activate the brake value encoder-brake pressure and provide this or a pressure derived therefrom as failure brake pressure at the failure brake port which in turn can then be connected, for example, to a redundancy port, for example, of a front axle modulator.

The disclosure is developed by the first failure brake valve and the second failure brake valve being configured as 3/2-way solenoid valves. In such an embodiment in which the failure brake valves are configured in each case as 3/2-way solenoid valves, it is possible to achieve advantageously the effect according to the described concept that the failure brake valve does not automatically switch into an open position in the inactivated state, since the magnetic part of the valve remains de-energized in the inactivated state and thus the valve is moved back into the open position, preferably by a restoring spring.

Preferably, a bistable valve is provided, the bistable valve being arranged in the valve main line and being configured for switching between a first position blocking the valve main line or connecting to a third bistable valve port and a second position connecting the valve main line. The third bistable valve port is preferably connected to a vent. Via such a bistable valve, the fail-safety valve unit can advantageously be operated both in a mode suitable for automatic operation of the vehicle and a mode suitable for manual operation of the vehicle. In particular, the bistable valve is configured such that in the first position blocking the valve main line, the valve main line is pneumatically connected at a first bistable valve port to a vent of the bistable valve, and the valve main line is blocked at a second bistable valve port, and in a second position pneumatically connecting the valve main line, the valve main line is pneumatically connected between the first and second bistable valve port and the vent of the bistable valve is blocked.

If the bistable valve is in a first position blocking the valve main line, a provision of a failure brake pressure at the failure brake port of the fail-safety valve unit is prevented per se, irrespective of the position of the failure brake valves. In this first position, a failure braking operation, which would be caused by a double fault, is prevented. This can be advantageously the case, in particular, with a manual operation of the vehicle, in particular when a human driver is intended to keep control of the vehicle. In contrast thereto, the bistable valve can be switched into a second position pneumatically connecting the valve main line, and thus—if all failure brake valves of the fail-safety valve unit are in an open position, the failure brake pressure can be provided at the failure brake port for triggering a failure braking operation of the vehicle. According to the concept of a bistable valve, it remains in its switched position and even in the de-energized state and, in particular, irrespective of any potential faults in the braking system. The bistable valve is preferably controlled via a valve control unit which in turn is connected to a control unit of the braking system and/or to a vehicle bus with signal and power transmission capability.

In an embodiment, the fail-safety valve unit-control port is connected to the third bistable valve port so that the brake value encoder-brake pressure can be provided at the third bistable valve port. This variant is particularly preferred if the brake value encoder is arranged upstream of the fail-safety valve unit and the fail-safety valve unit is thus arranged downstream of the brake value encoder. The fail-safety valve unit on the input side has two ports, namely the fail-safety valve unit-control port and the main port. The bistable valve mutually connects the main port and the fail-safety valve unit-control port to the valve main line of the fail-safety valve unit, so that either the first pressure P1 provided at the main port or the brake value encoder-brake pressure provided by the brake value encoder can be output into the valve main line.

Further preferably, the electronically controllable pneumatic braking system, preferably the fail-safety valve unit, includes a pressure control valve which is configured for limiting the first pressure and/or the failure brake pressure. Via the pressure control valve, a first pressure provided at the main port or a first pressure forwarded from the main port to the valve main line can be limited to a failure brake pressure which is suitable, in particular, for a failure braking operation. Typically, a vehicle should not be braked immediately with a maximum available pressure, since this can lead to the axles locking. This is to be avoided. The maximum pressure to be output can be dependent on the vehicle type, load status, speed, road conditions and similar parameters. For example, a low pressure limit can be provided with a heavily loaded vehicle, while a greater limit has to be provided with a lightly loaded or empty vehicle in order to prevent the axles locking.

In a further embodiment, the main port for receiving an output holding brake pressure or a pressure derived therefrom as first pressure is pneumatically connected to a holding brake function. The embodiment includes the knowledge that a permanent hold of the braked state of the vehicle is important for the safety of the vehicle. After a failure braking operation by the fail-safety valve unit, a leakage can occur in the service brake circuit carrying out the failure braking operation, in particular in a control line of a pneumatic front axle service brake circuit or on a front axle modulator or at a different point in a separate activation branch in which the fail-safety valve unit is arranged. In the case of such a leakage, if the connected compressed air supply continues to be emptied, it can lead to a drop in the failure brake pressure and thereby to a reduction in the effect of the failure braking operation.

As the main port is pneumatically connected to a holding brake function for receiving an output holding brake pressure as first pressure, it is advantageously achieved that in the case of a leakage occurring after a failure braking operation carried out by the fail-safety valve unit, the at least one spring brake cylinder is also pneumatically connected to the leaking part. In the described embodiment, a leakage thus leads to an actuation of the spring brake cylinder and thereby to a secure hold of the braked state of the vehicle. The actuation of the spring brake cylinder is achieved by the venting of the spring brake cylinder. Via a fail-safety valve unit configured according to the embodiment, therefore, the pneumatic connection of a service brake circuit carrying out the failure braking operation, such as for example the front axle brake circuit, is used with an output holding brake pressure in a targeted manner in order to compensate for the decreasing effect of the failure braking operation by the action of the deployed holding brake if there is a pressure loss in the service brake circuit. This process can be relatively slow, in the region of hours or even days, depending on the extent of the leakage. In various embodiments, however, it can also be provided that the spring-type cylinder is emptied immediately for implementing the failure braking operation and thus an actuation of the spring brake cylinders is achieved at the same time as the braking of the vehicle via the failure braking operation.

According to a further embodiment, the fail-safety valve unit has a selector valve with a first port which is pneumatically connected, in particular, to the holding brake function for receiving the first pressure, with a second port which is pneumatically connected to a further compressed air supply for receiving a further supply pressure as second pressure, and with a third port which is pneumatically connected to the failure brake valve, wherein the selector valve is configured to connect pneumatically to the third port that of the first and second port at which the higher pressure prevails. An embodiment with a selector valve which is preferably configured as a so-called select-high valve includes the knowledge that a redundant supply of compressed air to the fail-safety valve unit advantageously enhances the safety of the vehicle. Via a selector valve with a first port, which is pneumatically connected to a holding braking system for receiving the first pressure, it is advantageously possible to provide the availability of a first compressed air source for providing a failure brake pressure which, in particular, is independent of the compressed air source of the brake circuit used in normal operation, in particular a service brake circuit to which the failure brake pressure is provided. Thus a redundancy is already advantageously achieved by using a separate brake circuit. Via a second port of the selector valve, which is pneumatically connected to a further compressed air supply for receiving a further supply pressure as second pressure, advantageously a further compressed air source, which is present independently of the holding braking system, is provided as a further redundancy. The further compressed air supply can be, in particular, a compressed air supply of the service braking system. As the failure brake valve has a third port which is pneumatically connected to the failure brake valve, and the failure brake valve is configured to connect pneumatically to the third port that of the first and second port at which the higher pressure prevails (select-high valve), advantageously even with a failure of a compressed air source at one of the first and second ports, the other available compressed air source is automatically connected to the failure brake valve.

In a second aspect, the object mentioned in the introduction is achieved by a vehicle having a front axle, at least one rear axle and an electronically controllable pneumatic braking system according to one of the above-described preferred embodiments of an electronically controllable pneumatic braking system according to the first aspect of the disclosure.

### BRIEF DESCRIPTION OF DRAWINGS

The invention will now be described with reference to the drawings wherein:

FIG. 1 shows an electronically controllable pneumatic braking system according to a first embodiment;

FIG. 2 shows an electronically controllable pneumatic braking system according to a second embodiment;

FIG. 3 shows an electronically controllable pneumatic braking system according to a third embodiment;

FIG. 4 shows a detailed view of a fail-safety valve unit in a first embodiment;

FIG. 5 shows a fail-safety valve unit in a second embodiment;

FIG. 6 shows a fail-safety valve unit in a third embodiment;

FIG. 7 shows an electronically controllable pneumatic braking system in a fourth embodiment; and,

FIG. 8 shows an electronically controllable pneumatic braking system in a fifth embodiment.

### DETAILED DESCRIPTION

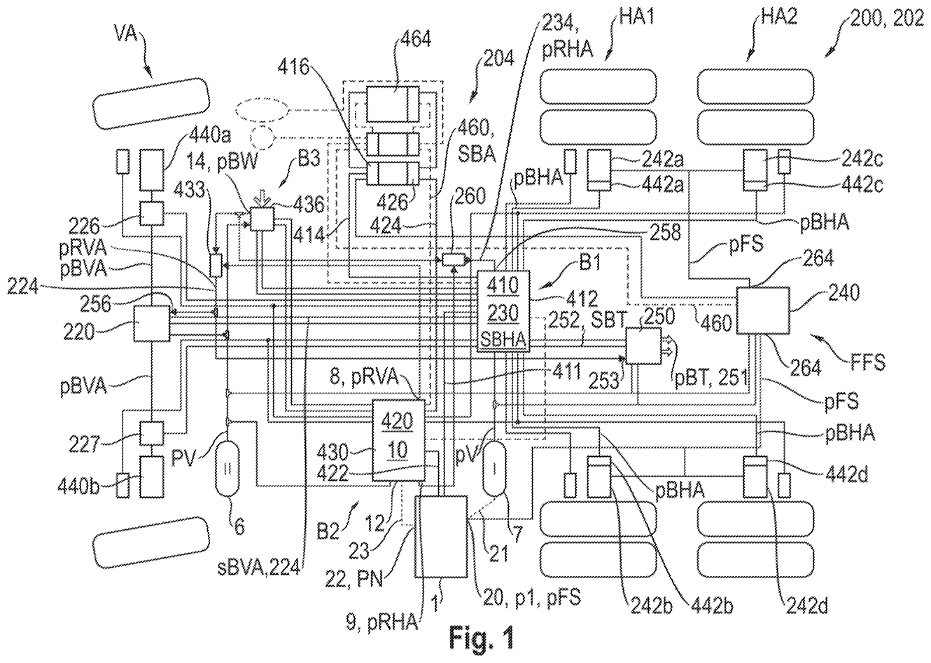

FIG. 1 illustrates a vehicle 200, namely in particular a utility vehicle 202, with a first axle, which in this case is a front axle VA, a second axle which in this case is a first rear axle HA1 and a third axle which in this case is a second rear axle HA2. The vehicle 200 includes an electronically controllable pneumatic braking system 204 which includes a primary system B1 and a first fallback level B2. In addition it also includes a second fallback level B3, as described hereinafter, and a fail-safety valve unit 1 which is configured to brake the vehicle 200 in the event that a double fault FD or a significant single fault occurs in the primary system B1 and the first and/or second fallback level B2, B3.

In the primary system B1 the electronically controllable pneumatic braking system 204 includes a first control unit 410 which is also configured as a central module 412 or is integrated in such a module, and which is connected via a vehicle bus 460 to a unit for autonomous driving 464 and receives braking request signals SBA therefrom. The first control unit 410 is supplied with electrical energy via a first supply line 414 from a first voltage source 416.

On the front axle VA the electronically controllable pneumatic braking system 204 includes a front axle modulator 220 which is configured in this case as a single-channel modulator and receives supply pressure pV from a first compressed air supply 6. To this end, the front axle modulator 220 includes in the known manner a front axle supply port 222 which is connected by pipework to the first compressed air supply 6. The front axle modulator 220 is connected via a front axle signal line 224 to the first control unit 410 and receives therefrom front axle brake signals SBVA which bring about a switching of one or more electromagnetic valves (not shown) of the front axle modulator 220, wherein as a result the front axle modulator 220 outputs a front axle brake pressure pBVA which is output via first and second ABS valves 226, 227 in a manner which is appropriate for each wheel on a first front axle service brake actuator 440a and a second front axle service brake actuator 440b. The front axle signal line 224 can be implemented, on the one hand, as direct cabling of the electromagnetic valves of the front axle modulator 220 to the first control unit 410, so that preferably output stages for electromagnetic valves of the front axle modulator 220 are integrated in the first control unit 410. Alternatively, the front axle signal line 224 can also be configured as a bus connection (CAN-BUS), in particular if the front axle modulator 220 has a separate intelligence.

The electronically controllable pneumatic braking system 204 also includes a rear axle modulator 230 which in this case is integrated in the central module 412 together with the first electronic control unit 410. The rear axle modulator 230 receives supply pressure pV from a second compressed air supply 7. The first electronic control unit 410 implements the braking request signals SBA received via the vehicle bus 206 in the rear axle brake signal SBH and switches one or more electromagnetic valves, not shown here in detail, of the rear axle modulator 230, thereby generating a rear axle service brake pressure pBHA which is output on first and second rear axle service brake actuators 442a, 442b on the first rear axle HA1 and on third and fourth rear axle service brake actuators 442ca, 442d on the second rear axle HA2. The rear axle service brake pressure pBHA in this case is output in a manner which is appropriate for each side and in this regard the rear axle modulator 230 is a two-channel modulator.

Additionally, the electronically controllable pneumatic braking system 204 shown here includes a parking brake unit 240 for forming a holding brake function FFS of the vehicle 200 which is also connected to the vehicle bus 460 and the first voltage source 416 and receives electrical energy therefrom. The parking brake unit 240 in this case is connected both to the first and to the second compressed air supply 6, 7 and receives supply pressure pV from both. The layout shown in FIG. 1 relates to a configuration which is primarily present in North America in which a separate parking brake supply is not provided. It should be understood that instead of the connection of the first and second compressed air supply 6, 7 to the parking brake unit 240, it is also possible to provide a third compressed air supply which supplies the parking brake unit 240 separately with supply pressure.

The parking brake unit 240 is provided to output a holding brake pressure pFS via a spring accumulator port 264 on first and second spring brake cylinders 242a, 242b on the first rear axle HA1 and third and fourth spring brake cylinders 242c, 242d on the second rear axle HA2.

The electronically controllable pneumatic braking system 204 is also provided for supplying a trailer and to this end has a trailer control unit 250 which also receives supply pressure pV both from the first compressed air supply 6 and from the second compressed air supply 7. The trailer control unit 250 is connected to the first control unit 410 and receives trailer brake signals SBT therefrom via a trailer signal line 252. In this regard, the trailer control unit 250 is also supplied by the first voltage source 416. As a function of the received trailer brake signal SBT, the trailer control unit 250 outputs a trailer brake pressure pBT at a trailer brake pressure port 251. It is possible to transmit via the trailer brake signal SBT, for example, a normal service brake signal, an anti-jack-knife brake signal for implementing an anti-jack-knife braking function or a trailer parking signal for parking the trailer.

For forming a first redundancy level B2 which in this case is electrically configured, the electronically controllable pneumatic braking system 204 includes a secondary brake module 421 in which the second electronic control unit 420 is also integrated. The secondary brake module 421 can be configured in a similar manner to, or include, a single-channel or double-channel axle modulator, as the redundancy valve unit 10 shown in the embodiment. The secondary brake module 421 in this case is also connected to the first compressed air supply 6 and receives supply pressure pV therefrom. The secondary brake module 421 is also connected to the vehicle bus 460 and receives braking request signals SBA thereby. The secondary brake module is supplied via a second supply line 424 from a second voltage source 426 which is independent of the first voltage source 416. The second electronic control unit 420 is able to process the braking request signals SBA and to activate the redundancy valve unit 10 in order to output a front axle redundancy pressure pRVA at a first redundancy brake pressure port 8 and a rear axle redundancy brake pressure pRHA at a second redundancy brake pressure port 9. The front axle redundancy pressure pRVA in this case is provided to the front axle VA, and the rear axle redundancy brake pressure pRHA is provided in this case to the rear axle HAL HA2. More specifically, the first front axle redundancy pressure pRVA is output in a manner known in principle via a first shuttle valve 433 at a front axle redundancy port 256 of the front axle modulator 220. The front axle modulator 220 then implements the front axle redundancy pressure pRVA received thereon and on the basis thereof outputs the front axle brake pressure pBVA redundantly. To this end, the front axle modulator 220 can have, in a manner known in principle, a monostable redundancy valve and a relay piston or a pneumatically switchable main valve in order to output the front axle redundancy pressure pRVA provided at the front axle redundancy port 256 with greater volume. The front axle redundancy pressure pRVA is also output at a trailer redundancy port 253 of the trailer control valve 250 in order to permit a redundant braking of a trailer.

Accordingly, the rear axle modulator 230, or the central module 412 in which the rear axle modulator 230 is integrated, has a rear axle redundancy port 258 at which the rear axle redundancy brake pressure pRHA can be provided via a second shuttle valve 260.

The secondary brake module 421 thus outputs the front axle redundancy brake pressure pRVA and the rear axle redundancy brake pressure pRHA in a manner which is appropriate for each axle and thus in turn can be denoted as a two-channel modulator. The central module 412 is configured in turn to output the rear axle brake pressure pBHA on the basis of the received rear axle redundancy brake pressure pRHA. To this end, the central module 412 can have, in a manner known in principle, a redundancy valve and a relay piston or a pneumatically switchable main valve in order to output the rear axle redundancy brake pressure pRHA as rear axle brake pressure pBHA with a greater volume. In this manner, an electronically controllable fallback level can be provided, in this case the first fallback level B2.

The electronically controllable pneumatic braking system 204 shown in FIG. 1 also has a manually actuatable second fallback level B3 which in the embodiment shown here includes a foot brake pedal as a brake value encoder 436. A brake value encoder-brake pressure pBW can be output both on the first shuttle valve 433 and on the second shuttle valve 260 via the brake value encoder 436. The first and second shuttle valves 433, 260 are configured in each case such that they output the higher of the prevailing brake value encoder-brake pressure pBW and the front or rear axle redundancy brake pressure pRVA, pRHA to the front axle modulator 220 or rear axle modulator 230. In this manner, for example, the output front or rear axle redundancy brake pressure pRVA, pRHA can be overridden by actuating the brake value encoder 436.

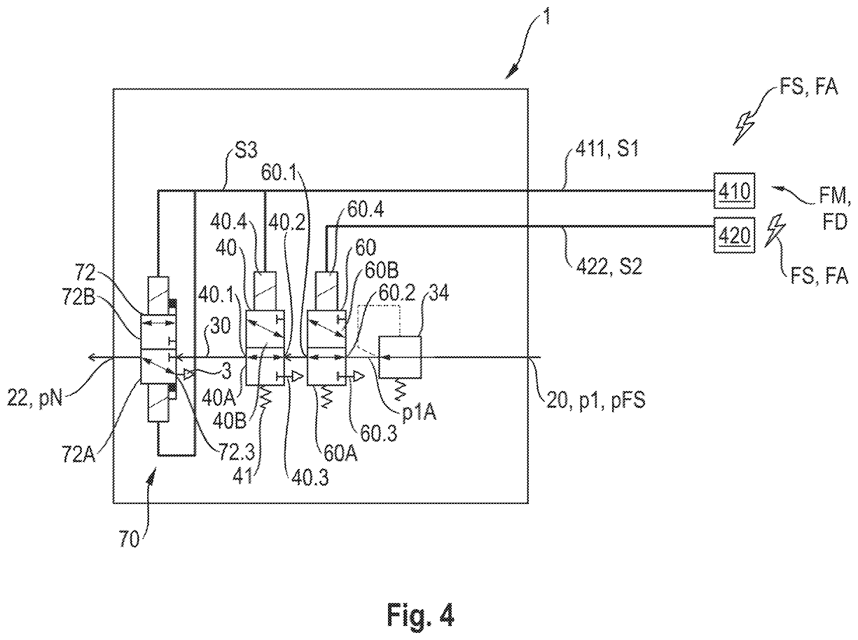

A third redundancy level which in this case is configured according to the disclosure as a fail-safe level, however, is formed by a fail-safety valve unit 1 which in this first embodiment (FIG. 1) is provided in the electronically controllable pneumatic braking system 204. The fail-safety valve unit is preferably configured to be monostable and has a main port 20 providing first pressure p1 and a failure brake port 22. The fail-safety valve unit 1 is connected to the first control unit 410 via a first control line 411 with signal and power transmission capability. The fail-safety valve unit 1 is also connected via a second control line 422 to the second control unit 420. The fail-safety valve unit 1 can be configured in principle as in US 2022/0274573. In a fault situation FF (see FIG. 4), power failure SF or diagnostic situation FD of the first control unit 410 and the second control unit 420, the fail-safety valve unit is provided to output a failure brake pressure pN at the failure brake port 22. This is already disclosed in principle in US 2022/0274573. In contrast to the disclosure therein, however, the failure brake port 22 according to the disclosure herein is connected to a failure control line 23 in which the failure brake pressure pN is output. In the embodiment shown in FIG. 1, the failure control line 23 is connected to the redundancy valve unit 10 or the secondary brake module 421, namely preferably to a failure control port 12 of the redundancy valve unit 10. In the embodiment shown here (FIG. 1), the redundancy valve unit 10 is configured to output the front axle redundancy pressure pRVA and the rear axle redundancy pressure pRHA as a function of the received failure brake pressure pN at the failure control port. To this end, the redundancy valve unit, for example, can have a monostable valve which in normal operation blocks out the failure brake pressure pN at the failure control port 12 in a de-energized operation or fault situation of the second control unit 420, but opens the corresponding monostable valve so that the failure brake pressure pN is forwarded directly from the failure control port 12 to the first and second redundancy brake pressure port, or is first modulated, such as for example increased in volume, throttled or otherwise modulated. If the redundancy valve unit 10 is constructed in the manner of a known two-channel axle modulator, in the context of the first embodiment (FIG. 1) the redundancy port which is generally present in such modulators can serve as a failure control port 12. It is merely important that the redundancy valve unit 10 is able to process the failure brake pressure pN in a de-energized state, and on the basis thereof to output the front axle redundancy brake pressure pRVA and rear axle redundancy brake pressure pRHA.

In the embodiment shown in FIG. 1, the main port 20 of the fail-safety valve unit 1 is connected to the holding brake function FFS and receives as first pressure p1 the holding brake pressure pFS output by the parking brake module 240. The holding brake pressure pFS is output in the normal driving mode of the vehicle 200 so that spring brake cylinders 242a to 242d are ventilated and opened. Since this pressure is used for providing the failure brake pressure pN, at the same time the spring brake cylinders 242a to 242d can also be partially or fully vented in order to achieve an additional braking action in this manner. Alternatively, it is also possible and preferred that the main port 20 is connected to the first compressed air supply 6 or the second compressed air supply 7, as indicated here by the failure main line 19 in dashed lines. In this manner, the supply pressure pV could be provided as first pressure p1 at the main port 20. It is also conceivable that, for example, both the second compressed air supply 7 and the holding brake function FFS are connected to the main port 20, preferably via a select-high valve so that respectively the higher of the supply pressure pV and the holding brake pressure pFS is provided at the main port 20 so that it is ensured that the failure brake pressure pN can always be provided. As a result, an availability of the system can be increased.

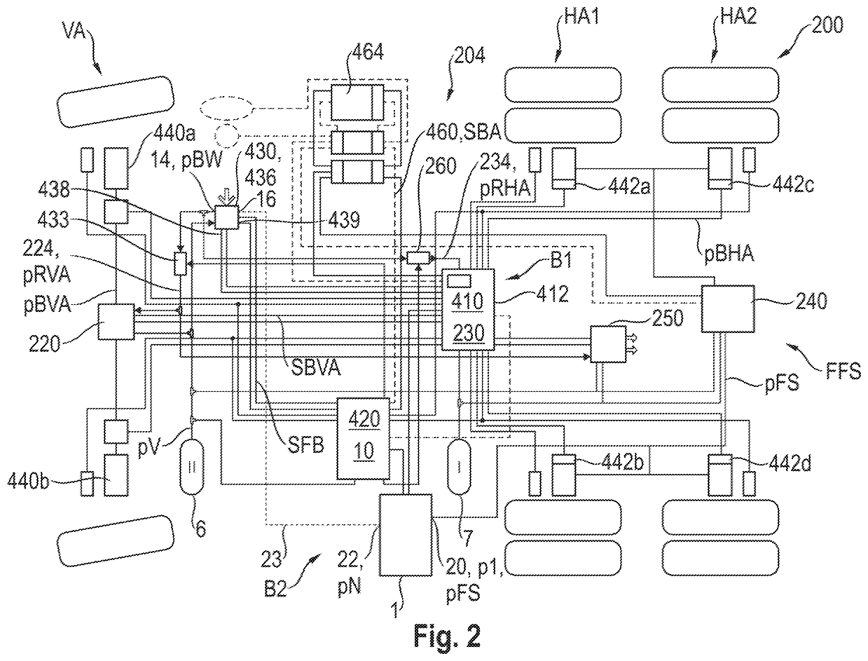

The second embodiment shown in FIG. 2 is substantially based on the first embodiment according to FIG. 1, so that elements which are the same or similar are denoted by the same reference signs as in FIG. 1. For these elements, reference is made in full to the above description and, in particular, the differences from the first embodiment (FIG. 1) are highlighted below.

The main difference in the second embodiment, in comparison with the first embodiment, is that the failure control line 23 is connected to the brake value encoder 436 rather than to the redundancy valve unit 10, the brake value encoder in this case forming a functional pneumatic unit 430. The brake value encoder 436 is configured as a so-called 1P2E-foot brake pedal which means that it has a pneumatic port, namely a brake value encoder-brake pressure port 14 and a first electrical port 438 and a second electrical port 439, wherein the first electrical port 438 is connected to the first electronic control unit 410 and the second electrical port 439 is connected to the second electrical control unit 420. Foot brake signals SFB can be provided thereby to the first and second control units 410, 420 in order to cause the first and second control units to provide corresponding front axle brake signals SBVA and rear axle brake signals SBHA.

The brake value encoder 436 according to the second embodiment (FIG. 2) shown here includes a brake value encoder-redundancy port 16 to which the fail-safety valve unit 1 is connected, more specifically the failure brake port 22 via the failure control line 23. In other words, the failure brake pressure pN is output at the brake value encoder-redundancy port 16. As already described with reference to FIG. 1, the brake value encoder 436 is pneumatically connected both to the first shuttle valve 433 and to the second shuttle valve 260 such that the brake value encoder-brake pressure pBW output thereby is also output on the first and second shuttle valves 433, 260. If the brake value encoder-brake pressure pBW exceeds the front axle redundancy pressure pRVA or rear axle redundancy pressure pRHA output by the redundancy valve unit 10, the brake value encoder-brake pressure pBW is instead forwarded by the first and second shuttle valves 433, 260 and correspondingly output on the front axle modulator 220 and the rear axle modulator 230. The brake value encoder 436 is formed such that in the event that the failure brake pressure pN is provided, this is output by the brake value encoder 436, either unchanged, increased in volume or modulated in another manner, and is output at the brake value encoder-brake pressure port 14. Since in a state when the failure brake pressure pN is output the redundancy valve unit 10 is typically de-energized and thus can output neither the front axle redundancy pressure pRVA nor the rear axle redundancy pressure pRHA, the activated failure brake pressure pN exceeds this such that both the first shuttle valve 433 and the second shuttle valve 260 activate the failure brake pressure pN (or the correspondingly modulated pressure) and in this manner provide it to the front axle modulator 220 and the rear axle modulator 230, which then in response thereto output the front axle brake pressure pBVA and rear axle brake pressure pBHA redundantly. In turn it should also be understood that the main port 20 can be connected not only to the holding brake function FFS as shown in FIG. 2 but also to the first or second compressed air supply 6, 7.

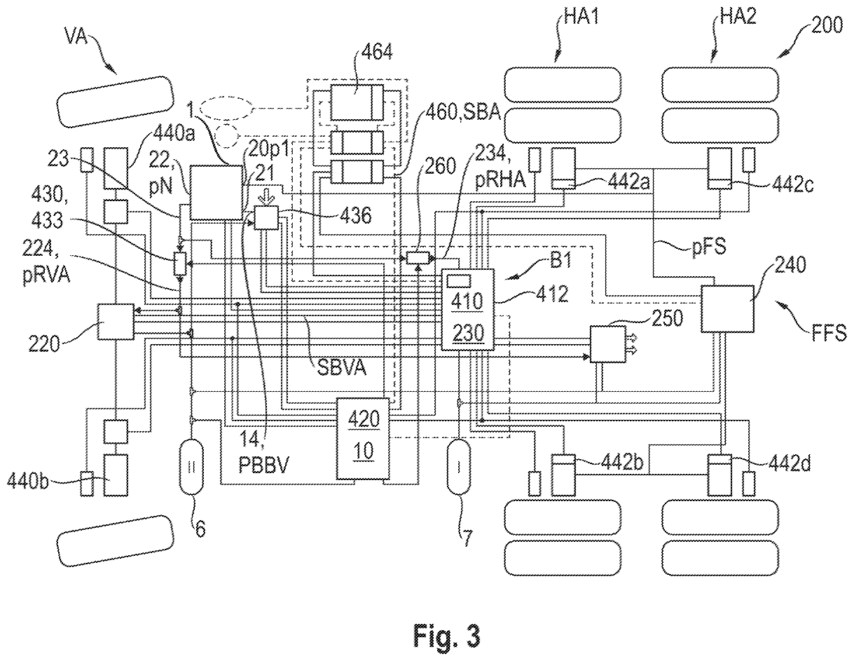

A third embodiment (FIG. 3) of the electronically controllable pneumatic braking system 204 is based on the first two embodiments (FIGS. 1, 2), wherein the differences from the first two embodiments are highlighted below. The essential difference in the third embodiment is in the positioning of the fail-safety valve unit 1 in the braking system 204. The main port 20 is connected in turn to the holding brake function FFS and thus receives the holding brake pressure pFS as the first pressure p1, but can also be connected to the first compressed air supply 6 or the second compressed air supply 7. In the embodiment shown in FIG. 3 the failure brake port 22 is directly connected via the failure control line 23 to the first shuttle valve 433 and the second shuttle valve 260, namely via Y-cabling. In this manner, the failure brake pressure pN is output both on the first shuttle valve 433 and on the second shuttle valve 260 so that both the front axle VA and the rear axles HAL HA2 can be braked via the failure brake pressure pN. This case is similar to the case described in the second embodiment with reference to FIG. 2. The brake value encoder 436 in this case is looped through the fail-safety valve unit 1 and connected thereto, more specifically to a fail-safety valve unit-control port 21. This can be connected to the failure brake port 22 via one or more valves, so that in normal operation the brake value encoder-brake pressure pBW can be output at the failure brake port 22; in the event that the fail-safety valve unit 1 is active, however, instead of the brake value encoder-brake pressure pBW, the failure brake pressure pN is output at the failure brake port 22 or even respectively the higher of the brake value encoder-brake pressure pBW and the failure brake pressure pN.

FIGS. 3 to 6 show three different embodiments of the fail-safety valve unit 1 as can be used in the embodiments of FIGS. 1 to 3.

The fail-safety valve unit 1 has a first monostable failure brake valve 40 and a second monostable failure brake valve 60.

The first failure brake valve 40 is connected via the first control line 411 with signal and power capability to a first control unit 410. The first control unit 410 is assigned to a primary system B1 of the braking system 204. The second failure brake valve 60 is connected via the second control line 422 to the second control unit 420 with signal and power transmission capability. The second control unit 420 is assigned to a first fallback level B2 of the braking system 204.

The two failure brake valves 40, 60 are pneumatically connected in series in a valve main line 30 of the fail-safety valve unit 1. The valve main line 30 extends from the main port 20 to the failure brake port 22.

Both failure brake valves 40, 60 are shown in the present case in a non-activated and de-energized state, in which they are respectively in an open position 40A, 60A. In the first open position 40A, a pneumatic connection is produced between a first valve port 40.1 and a second valve port 40.2 of the first failure brake valve 40. In the second open position 60A, a pneumatic connection is produced between a first valve port 60.1 and a second valve port 60.2 of the second failure brake valve 60. If both failure brake valves 40, 60 are respectively in the open position 40A, 60A, a pressure can be output from the main port 20 to the failure brake port 22 for the purpose of providing a failure brake pressure pN.

By providing a first control signal S1 via the first control line 412, the first failure brake valve 40 can be switched from the open position 40A counter to the resistance of a first restoring spring 41 into a first blocked position 40B. In the blocked position 40B a pneumatic connection is produced between the first valve port 40.1 and a first venting port 40.3. By providing a second control signal S2 via the second control line 422, the second failure brake valve 60 can be switched from the open position 60A counter to the resistance of a second restoring spring 61 into a second blocked position 60B. In the blocked position 60B a pneumatic connection is produced between the first valve port 60.1 and a second venting port 60.3.

In normal operation of the vehicle 200, in particular, it is provided that the two failure brake valves 40, 60 are in their respective blocked position 40B, 60B. In this state, therefore, there is no pneumatic connection between the main port 20 and the failure brake port 22 since the pneumatic connection is interrupted on at least two points, namely on the first failure brake valve 40 and on the second failure brake valve 60.

In the case of a multiple fault FM, in particular a double fault FD, that is, when both a first control signal S1 and a second control signal S2 are absent at the same time, and a first magnetic part 40.4 of the first failure brake valve 40 and a second magnetic part 60.4 of the second failure brake valve 60 are thus de-energized, both the first failure brake valve 40 and the second failure brake valve 60 return automatically into their open position 40A, 60A by the restoring force generated by the respective restoring spring 41, 61.

Such a double fault FD can arise, for example, due to a simultaneous power failure FS both in the primary system B1 and in the first fallback level B2, when both the first control unit 410 and the second control unit 420 are without a energy supply. In the case of such a simultaneous power failure, accordingly no control signal S1, S2 can be forwarded to the failure brake valves 40, 60.

Moreover, a double fault FD can also be manifested by an exceptional fault FA occurring both in the first control unit 410 and in the second control unit 420, and a zero signal is switched from the respective control unit 410, 420 as a fault measure (in particular in the absence of other program alternatives) and thus the control signals S1, S2 are deliberately set to 0 for switching the failure brake valves 40, 60 into the open position 40A, 60A. Different types of fault can be present in the individual control units 410, 420 for the presence of a multiple fault FM, for example in the case of a double fault FD a power failure FA can be present in a control unit 410, 420 and an exceptional fault FA can be present in the respective other control unit 410, 420.

The fail-safety valve unit 1 also has a pressure control valve 34 which in the present case is arranged in the valve main line 30 between the main port 20 and the second failure brake valve 60, such that a first pressure p1 prevailing at the main port 20 is limited to a fixed value set manually on the pressure control valve 34, before it is provided at the failure brake port 22 as failure brake pressure pN. The value set manually on the pressure control valve 34 is generally set once or is in a preset delivery state and in this case is not changed again during the operation of the braking system.

The fail-safety valve unit 1 also has a bistable valve unit 70 with a bistable valve 72 which is arranged in the valve main line 30. The bistable valve 72 is shown in the present case in a second position 72B in which a pneumatic connection is produced between a first bistable valve port 72.1 and a second bistable valve port 72.2. In a first position 72A of the bistable valve 72 the second bistable valve port 72.2 is blocked and a pneumatic connection is produced between the first bistable valve port 72.1 and a third bistable valve port 72.3 which in this case is connected to a vent 3. The bistable valve 72 is activated via a third switching signal S3 which is provided in this case by the first control unit 410. For the autonomous operation of the vehicle 200, the bistable valve 72 is preferably moved into the second switching position 72B, while in manual operation of the vehicle 200 the bistable valve is in the first switching position 72A. In this manner, the output of the failure brake pressure pN can be prevented in manual operation. If such a changeover is not desired, the bistable valve 72 can also be dispensed with.

The fail-safety valve unit 1 can have a pressure sensor, not shown here, in particular for checking the function of the failure brake valves 40, 60 for plausibility.

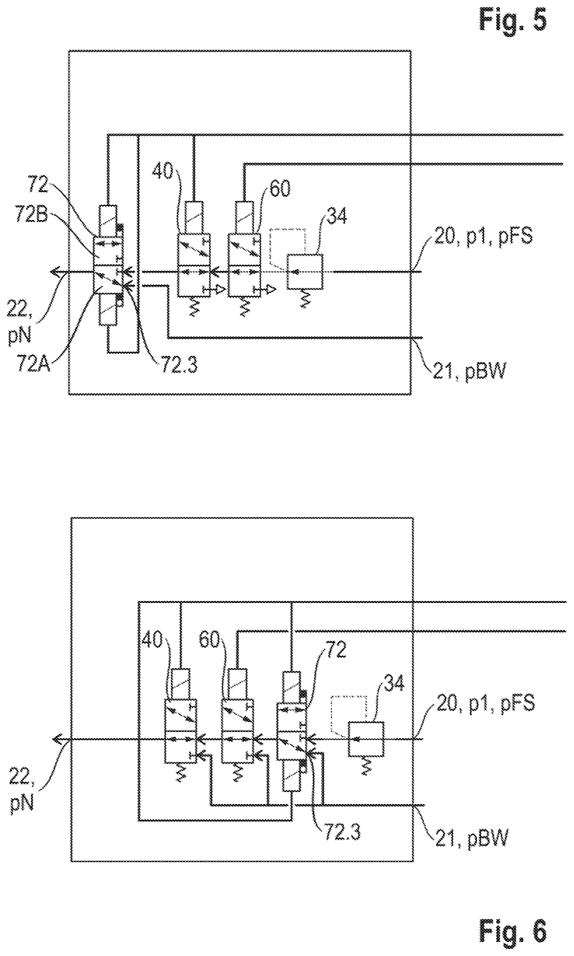

FIGS. 5 and 6 are based in turn on FIG. 4, wherein elements which are the same or similar are provided with the same reference signs, so that reference is made in full to the above description. Moreover, in particular, differences from the first embodiment of the fail-safety valve unit 1 are highlighted below.

The second embodiment shown in FIG. 5 of the fail-safety valve unit 1 differs from the first embodiment of the fail-safety valve unit 1 according to FIG. 4 in that, in particular, it is provided for use in the embodiment shown in FIG. 2 of the electronically controllable pneumatic braking system 204. In this regard, the fail-safety valve unit 1 includes a fail-safety valve unit-control port 21 to which the brake value encoder 436 is connected and to which the brake value encoder-brake pressure pBW is output. The fail-safety valve unit-control port 21 is connected to the third bistable valve port 72.3 rather than the vent 3 (see FIG. 4). For manual operation of the vehicle 200, the bistable valve 72 should be switched to the first switching position 72A, while in autonomous operation the bistable valve should be in the second switching position 72B. The brake value encoder-brake pressure pBW can be activated only in the first switching position 72A in order to be able to output the front axle brake pressure pBVA and the rear axle brake pressure pBHA.

In the third embodiment of the fail-safety valve unit 1 (FIG. 6), the sequence of the first and second failure brake valves 40, 60 with the bistable valve 72 is reversed. Between the main port 20 and the failure brake port 22, the bistable valve 72 is arranged upstream of the first and second failure brake valves 40, 60, viewed in the direction of flow. In this regard, the fail-safety valve unit-control port 21 is not only connected to the third bistable valve port 72.3 but also to the first and second venting ports 40.3, 60.3 of the first and second failure brake valves, in order to permit an output of the brake value encoder-brake pressure pBW.

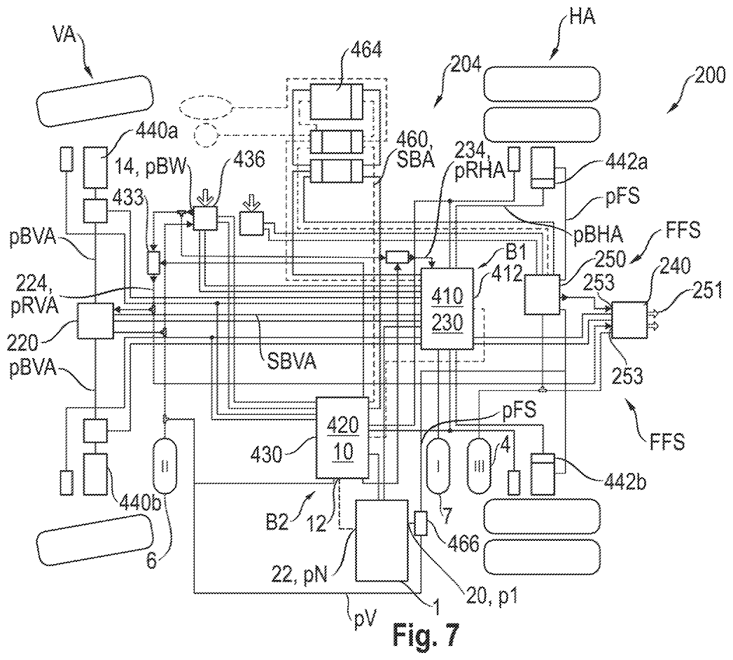

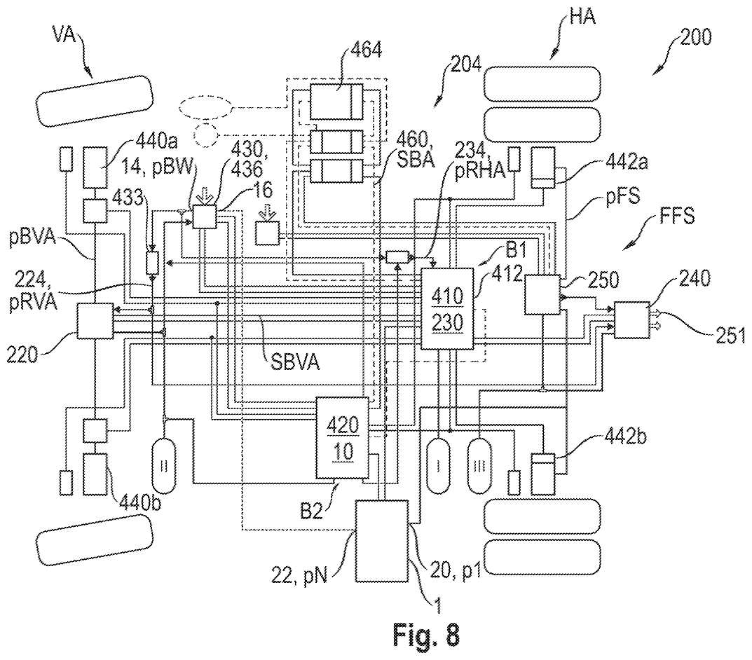

FIGS. 7 and 8 show by way of example on the basis of the embodiments of FIGS. 1 and 2 a layout of an electronically controllable pneumatic braking system 204 which is suitable and provided for the European market. In turn, elements which are the same and similar are provided with the same reference signs and in this regard reference is made in full to the above description. In particular, the differences from the first three embodiments of the electronically controllable pneumatic braking system 204 according to FIGS. 1 to 3 are highlighted below.

The essential difference is in the configuration of the parking brake unit 240 and the trailer control unit 250. The parking brake unit 240 has, in contrast to FIGS. 1 to 3, a separate parking brake supply 4 and is not fed from the first compressed air supply 6 and the second compressed air supply 7. The trailer is also fed via this parking brake supply 4 so that the trailer control unit 240 is also connected thereto. A redundant activation of the trailer or the parking brake unit 240 via the trailer redundancy port 253 is also activated from the parking brake unit 240 and not only from the front axle VA.

A further difference is that the main port 20 in this case is connected to a third shuttle valve 466 which, on the one hand, is connected to the holding brake function FFS and receives holding brake pressure pFS and, on the other hand, is connected to the first compressed air supply 6 and receives supply pressure pV therefrom. The third shuttle valve 466 outputs in each case the higher of the holding brake pressure pFS and the supply pressure pV at the main port 20.

The fifth embodiment (FIG. 8) is a combination of the fourth embodiment (FIG. 7) and the second embodiment (FIG. 2).

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

1 Fail-safety valve unit
3 Vent
4 Parking brake supply
6 First compressed air supply
7 Second compressed air supply
8 First redundancy brake pressure port
9 Second redundancy brake pressure port
10 Redundancy valve unit
12 Failure control port
14 Brake value encoder-brake pressure port
16 Brake value encoder-redundancy port
19 Failure main line
20 Main port
21 Fail-safety valve unit-control port
22 Failure brake port
23 Failure control line
30 Valve main line
34 Pressure control valve
40 First failure brake valve
40A First open position
40B Second blocked position
40.1 First valve port of first failure brake valve
40.2 Second valve port of first failure brake valve
40.3 First venting port
40.4 First magnetic part
41 First restoring spring
60 Second failure brake valve
60A Second open position
60B Second blocked position
60.1 First valve port of second failure brake valve
60.2 Second valve port of second failure brake valve
60.3 Second venting port
60.4 Second magnetic part
61 Second restoring spring
70 Bistable valve unit
72 Bistable valve
72A First position of bistable valve
72B Second position of bistable valve
72.1 First bistable valve port
72.2 Second bistable valve port
72.3 Third bistable valve port
200 Vehicle
202 Utility vehicle
204 Electronically controllable pneumatic braking system
220 Front axle modulator
222 Front axle supply port
224 Front axle signal line
226 First ABS valve
227 Second ABS valve
230 Rear axle modulator
240 Parking brake unit
242a First spring brake cylinder
242b Second spring brake cylinder
242c Third spring brake cylinder
242d Fourth spring brake cylinder
250 Trailer control unit
252 Trailer signal line
253 Trailer redundancy port
256 Front axle redundancy port
260 Second shuttle valve
264 Spring accumulator port
410 First control unit
411 First signal line
412 Central module
414 First supply line
416 First voltage source
420 Second control unit
421 Secondary brake module
422 Second control line
424 Second supply line
426 Second energy supply
430 Functional pneumatic unit
433 First shuttle valve
436 Brake value encoder
438 First electrical port
439 Second electrical port
440a First front axle service brake actuator
440b First front axle service brake actuator
442a First rear axle service brake actuator
442b Second rear axle service brake actuator
442c Third rear axle service brake actuator
442d Fourth rear axle service brake actuator
460 Vehicle bus
464 Unit for autonomous driving
466 Third shuttle valve
B1 Primary system
B2 First fallback level
B3 Second fallback level
FFS Holding brake function
HA1 First rear axle
HA2 Second rear axle
p1 First pressure
pBHA Rear axle service brake pressure
pBT Trailer brake pressure
pBVA Front axle service brake pressure
pBW Brake value encoder-brake pressure
pFS Holding brake pressure
pN Failure brake pressure
pRHA Rear axle redundancy brake pressure
pRA Front axle redundancy pressure
pV Supply pressure
S1 First control signal
S2 Second control signal
SBA Braking request signals
SBT Trailer brake signals
SBVA Front axle brake signals
VA Front axle

1. An electronically controllable pneumatic braking system for a vehicle, the electronically controllable pneumatic braking system comprising:
a first control unit for a primary system and a second control unit for a first fallback level, wherein said first control unit and said second control unit are configured to at least one of be supplied with energy independently of one another and at least partially replace one another in terms of function;
a monostable fail-safety valve unit pneumatically connecting a main port, which provides a first pressure, and a failure brake port;
said monostable fail-safety valve unit being connected both to said first control unit and to said second control unit and, in at least one of a fault situation, a power failure situation, and a diagnostic situation of said first control unit and said second control unit, provides a failure brake pressure at said failure brake port; and,
wherein, in order to provide the failure brake pressure for triggering a failure braking operation of the vehicle, said failure brake port is connected to the primary system and/or to the first fallback level upstream of a functional pneumatic unit of at least one of said primary system and said first fallback level, such that both front axle service brake actuators and rear axle service brake actuators have a brake pressure applied thereto in order to implement the failure braking operation.

2. The electronically controllable pneumatic braking system of claim 1, wherein:
said monostable fail-safety valve unit has a first failure brake valve configured as a monostable valve, a second failure brake valve configured as a monostable valve, and a valve main line;
said first failure brake valve and said second failure brake valve are pneumatically connected in series in said valve main line; and,
said first failure brake valve is controllable by said first control unit and said second failure brake valve is controllable by said second control unit and said failure brake valves in the inactivated state are in an open position such that a first pressure applied to said main port or a pressure derived from the first pressure is provided as the failure brake pressure at said failure brake port.

3. The electronically controllable pneumatic braking system of claim 1 further comprising:
a front axle modulator electronically connected to said first control unit and configured to receive front axle service brake signals from said first control unit and in response thereto provide a front axle service brake pressure on a first front axle service brake actuator and a second front axle service brake actuator on a front axle of the vehicle; and,
a rear axle modulator electronically connected to said first control unit and configured to receive rear axle service brake signals from said first control unit and in response thereto provide a rear axle service brake pressure on at least one first rear axle service brake actuator and a second rear axle service brake actuator on a rear axle of the vehicle.

4. The electronically controllable pneumatic braking system of claim 3, wherein said rear axle modulator and said first control unit are integrated as a structural unit to form a central module.

5. The electronically controllable pneumatic braking system of claim 3, wherein said first control unit is connected to an autonomous driving unit via a vehicle bus and is configured to receive braking request signals from the autonomous driving unit and on a basis of the received braking request signals provides at least one of the front axle service brake signals and the rear axle service brake signals.

6. The electronically controllable pneumatic braking system of claim 1 further comprising:
a front axle redundancy pressure line into which a front axle redundancy pressure can be input for the redundant braking of a front axle and a rear axle redundancy pressure line into which a rear axle redundancy pressure can be input for the redundant braking of at least one rear axle.

7. The electronically controllable pneumatic braking system of claim 1 further comprising a redundancy valve unit configured to be activated by said second control unit.

8. The electronically controllable pneumatic braking system of claim 7, wherein said redundancy valve unit is configured to input a front axle redundancy pressure into a front axle redundancy pressure line.

9. The electronically controllable pneumatic braking system of claim 7, wherein said redundancy valve unit is configured to input a rear axle redundancy pressure into a rear axle redundancy pressure line.

10. The electronically controllable pneumatic braking system of claim 7, wherein said second control unit is connected via a vehicle bus to an autonomous driving unit and is configured to receive braking request signals from said autonomous driving unit.

11. The electronically controllable pneumatic braking system of claim 7, wherein said redundancy valve unit has a failure control port which is connectable or is connected to said failure brake port; and, said redundancy valve unit is configured to output at least one of a front axle redundancy pressure and a rear axle redundancy pressure pneumatically on a basis of the failure brake pressure.

12. The electronically controllable pneumatic braking system of claim 6 further comprising:
a brake value encoder having at least one brake value encoder-brake pressure port for providing a brake value encoder-brake pressure; and,
said brake value encoder-brake pressure port being connected or connectable to at least one of said front axle redundancy pressure line and said rear axle redundancy pressure line.

13. The electronically controllable pneumatic braking system of claim 12, wherein said brake value encoder has a brake value encoder-redundancy port which is connected to said failure brake port; and, said brake value encoder is configured to output the brake value encoder-brake pressure pneumatically on a basis of the failure brake pressure.

14. The electronically controllable pneumatic braking system of claim 12, wherein:
said brake value encoder-brake pressure port is connected to a fail-safety valve unit-control port of said monostable fail-safety valve unit; and,
in the absence of at least one of the fault situation, the power failure situation, and the diagnostic situation of said first control unit and said second control unit, said fail-safety valve unit is configured to connect said fail-safety valve unit-control port to said failure brake port for activating said brake value encoder-brake pressure.

15. The electronically controllable pneumatic braking system of claim 2, wherein said first failure brake valve and said second failure brake valve are 3/2-way solenoid valves.

16. The electronically controllable pneumatic braking system of claim 2 further comprising a bistable valve arranged in said valve main line and configured to switch between a first position blocking said valve main line or connecting to a third bistable valve port and a second position connecting said valve main line.

17. The electronically controllable pneumatic braking system of claim 14 further comprising:
a bistable valve arranged in said valve main line and configured to switch between a first position blocking said valve main line or connecting to a third bistable valve port and a second position connecting said valve main line;
said fail-safety valve unit having a first failure brake valve configured as a monostable valve, a second failure brake valve configured as a monostable valve, and a valve main line;
said first failure brake valve and said second failure brake valve being pneumatically connected in series in said valve main line;
said first failure brake valve being controllable by said first control unit and the second failure brake valve being controllable by said second control unit and said failure brake valves in the inactivated state being in an open position such that a first pressure applied to said main port or a pressure derived from the first pressure is provided as the failure brake pressure at said failure brake port; and,
said fail-safety valve unit-control port being connected to said third bistable valve port so that the brake value encoder-brake pressure is providable at said third bistable valve port.

18. The electronically controllable pneumatic braking system of claim 2, further comprising a pressure control valve configured to limit at least one of the first pressure and the failure brake pressure.

19. The electronically controllable pneumatic braking system of claim 2, wherein said main port for receiving an output holding brake pressure or a pressure derived therefrom as the first pressure is pneumatically connected to a holding brake function.

20. The electronically controllable pneumatic braking system of claim 2, wherein:
said fail-safety valve unit includes a selector valve having a first port which is pneumatically connected to a holding brake function for receiving the first pressure;
said selector valve has a second port which is pneumatically connected to a further compressed air supply for receiving a further supply pressure as a second pressure;
said selector valve has a third port which is pneumatically connected to said failure brake valve; and,
said selector valve is configured to pneumatically connect said third port to said first port when the first pressure is higher than the second pressure and to pneumatically connect said third port to said second port when the second pressure is higher than the first pressure.

21. A vehicle comprising:
a front axle;
at least one rear axle;
an electronically controllable pneumatic braking system having a first control unit for a primary system and a second control unit for a first fallback level, wherein said first control unit and said second control unit are configured to at least one of be supplied with energy independently of one another and at least partially replace one another in terms of function;
said electronically controllable pneumatic braking system having a monostable fail-safety valve unit pneumatically connecting a main port, which provides a first pressure, and a failure brake port;
said monostable fail-safety valve unit being connected both to said first control unit and to said second control unit and, in at least one of a fault situation, a power failure situation, and a diagnostic situation of said first control unit and said second control unit, provides a failure brake pressure at said failure brake port; and,
wherein, in order to provide the failure brake pressure for triggering a failure braking operation of the vehicle, said failure brake port is connected to the primary system and/or to the first fallback level upstream of a functional pneumatic unit of at least one of said primary system and said first fallback level, such that both front axle service brake actuators and rear axle service brake actuators have a brake pressure applied thereto in order to implement the failure braking operation.
